(19) United States
(12) Patent Application Publication
(10) Pub. No.: US 2024/0218615 A1
(43) Pub. Date: Jul. 4, 2024

(54) SYSTEM AND METHOD FOR ROBOTIC SEALING OF DEFECTS IN PAVED SURFACES

(71) Applicant: Crafco, Inc., Chandler, AZ (US)

(72) Inventors: Austin Van Putten, Wyoming, MI (US); Jarod Hanko, Jenison, MI (US)

(21) Appl. No.: 18/092,873

(22) Filed: Jan. 3, 2023

(51) Int. Cl. E01C 23/07; E01C 23/01; G06T 7/00

(52) U.S. Cl. CPC E01C 23/07; E01C 23/01; G06T 7/0008; G06T 2207/30132

(57) ABSTRACT

Systems and methods for pave surface management are described. A system for identifying and sealing cracks of a paved surface can include a camera and a robotic arm coupled to a vehicle, and a processor. The robotic arm includes one or more actuators configured to affect motion of the robotic arm and a distal sealant applicator. The processor is configured to selectively trigger the camera to capture images of the paved surface, determine that a plurality of pixels for each captured image meets or surpasses a similarity threshold of a crack using image recognition, generate a priority list of the plurality of pixels based on a cost function, and command the robotic arm to apply sealant to the paved surface at locations corresponding to each of the plurality of pixels based on the priority list.

### TECHNICAL FIELD

The present disclosure relates to paved surface maintenance technology and, in particular, to systems for use in automatically identifying and sealing cracking on road segments.

### BACKGROUND

With the development of modern road networks, the maintenance and management of pavement has become increasingly prominent. Conventionally, manual detection has been used to evaluate road conditions, such as holes and cracks in roads. In some conventional road condition management approaches, an engineer visually checks the number of cracks in the road and calculates a crack ratio, a general estimate for linear feet of cracks per unit area, for each portion of road. Later, a crew size of 4 to 7 people work to manually seal cracks for several lane miles each day. This sealing is inconsistent, as workers get tired and must make quick decisions on what to seal, and dangerous, as workers are exposed to traffic and have to work in close proximity with scalding hot sealant. These approaches suffer from low efficiency and interference of subjective factors, particularly when large road networks are considered.

Conventional approaches that have sought to remove the manual labor of road condition management often incorporate specially designed pavement detection vehicles or comprehensive rigs that require 3D cameras and sophisticated technology. The cost of these pavement detection vehicles is often prohibitively expensive for use in estimating repair cost for road segments and fail to automate the crack sealing process. Furthermore, automated solutions that do exist fail to incorporate a hot air lance, resulting in less effective seals. Additionally, some conventional pavement detection systems require a shroud or cover of the road surface being analyzed, increasing cost and use complexity.

### SUMMARY

Embodiments of the present disclosure address the deficiencies of conventional solutions by providing automated systems and methods that rapidly identify road distresses in collected pavement surface data for intelligent decision support of large road networks. The automated systems and methods then leverage this analysis to clean, prepare, and seal identified road distresses in a consistent and reliable manner while reducing cost, increasing safety, and ensuring quality standards.

In one aspect, the present disclosure provides for a system for identifying and sealing cracks of a paved surface. The system can include a camera and a robotic arm coupled to a vehicle, and a processor. The robotic arm includes one or more actuators configured to affect motion of the robotic arm and a distal sealant applicator. The processor is configured to selectively trigger the camera to capture images of the paved surface, determine that a plurality of pixels for each captured image meets or surpasses a similarity threshold of a crack using image recognition, generate a priority list of the plurality of pixels based on a cost function, and command the robotic arm to apply sealant to the paved surface at locations corresponding to each of the plurality of pixels based on the priority list.

In another aspect, the present disclosure provides for a method of identifying and sealing cracks of a paved surface. The method comprises capturing images of the paved surface with a camera coupled to a vehicle, determining, for each captured image using image recognition, that a plurality of pixels meets or surpasses a similarity threshold of a crack, generating a priority list of the plurality of pixels based on a cost function, actuating one or more motors of a robotic arm coupled to the vehicle and including a distal sealant applicator such that the distal sealant applicator is proximate to a location of the paved surface corresponding to the plurality of pixels based on the priority list, and applying sealant to the location via the distal sealant applicator.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is a front perspective view of a system for identifying and sealing cracks of a paved surface, according to an embodiment.

FIG. 1B is a partial perspective view of the system of FIG. 1A.

FIG. 1C is a left-side view of the system of FIG. 1A.

FIG. 1D is a right-side view of the system of FIG. 1A.

FIG. 1E is a top-down view of the system of FIG. 1A.

FIG. 1F is a bottom-up view of the system of FIG. 1A.

FIG. 2 is a perspective view of a camera mounting rig for portable pavement repair estimation according to an embodiment.

FIG. 3 is a block diagram of a system for identifying and sealing cracks of a paved surface according to an embodiment.

FIG. 4 is a top-down view of images stitched together using ArUco markers according to an embodiment.

FIG. 5A is a top-down view of an image of pavement segment according to an embodiment.

FIG. 5B is a top-down view of cracks present within the image of FIG. 5A.

FIG. 6 is a collection of graphs representing a cost function applied to the reach of a robotic arm according to an embodiment.

FIG. 7 is a graph of the area of reach of a robotic arm according to an embodiment.

FIG. 8 is a flowchart of a method for acquiring and processing pavement images according to an embodiment.

FIG. 9 is a flowchart of a method for analyzing images of pavement segments according to an embodiment.

FIG. 10 is a flowchart of a method for identifying and sealing cracks of a paved surface according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments of the present disclosure include a portable paved surface sealing system that uses one or more camera inputs to detect paved surface features, conduct intelligent path planning, and seal paved surface features, such as cracks, in real time. The system incorporates a visual module configured to combine the views of multiple cameras positioned around a vehicle to detect cracks and other anomalies in pavement while moving and a robotic sealing module configured to perform pavement repair. The system can be removably coupled to a vehicle and operated by a single driver. In operation the system takes images of a pavement surface, identifies cracks using machine learning, plans a path for the sealant arm, and activates a sealant applicator all while the vehicle is in motion.

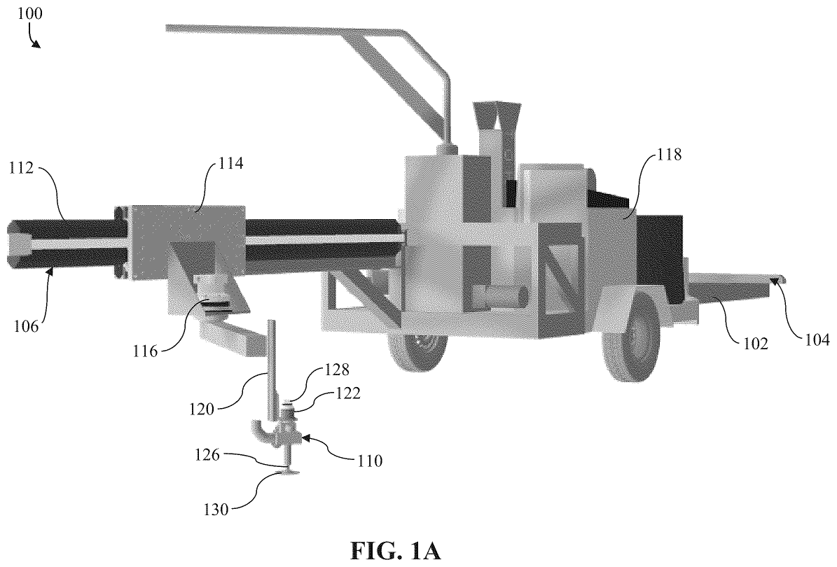

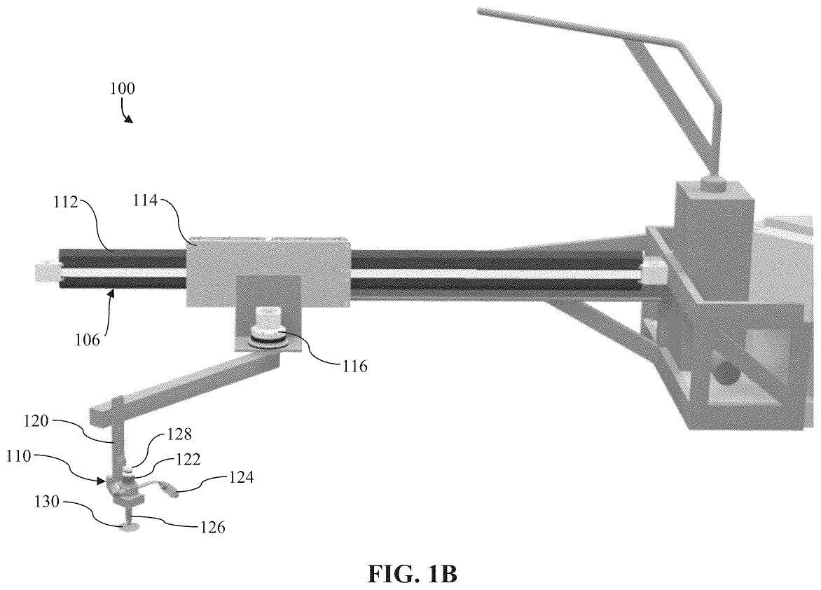

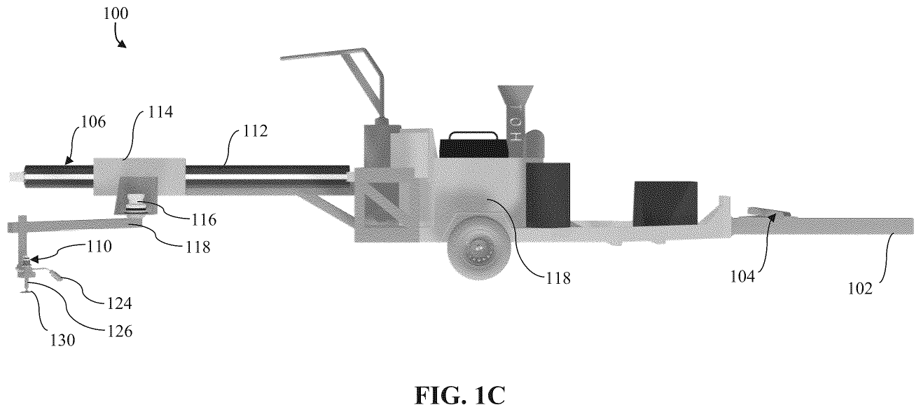

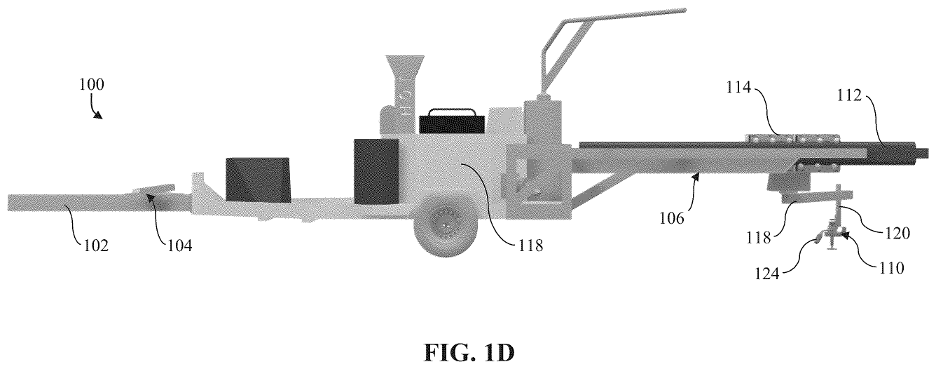

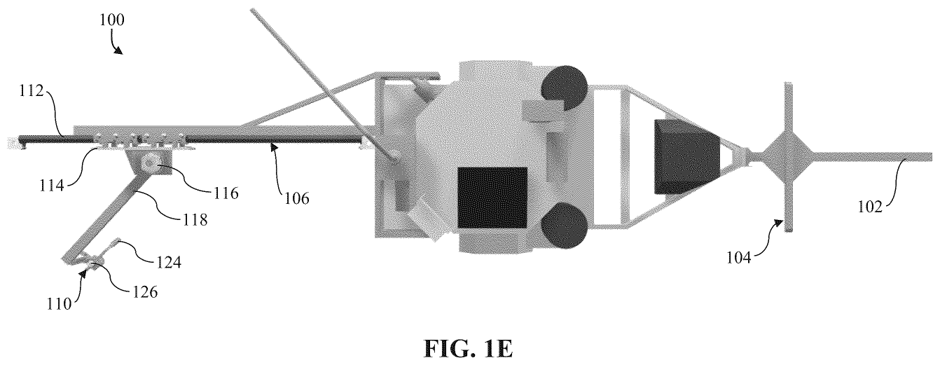

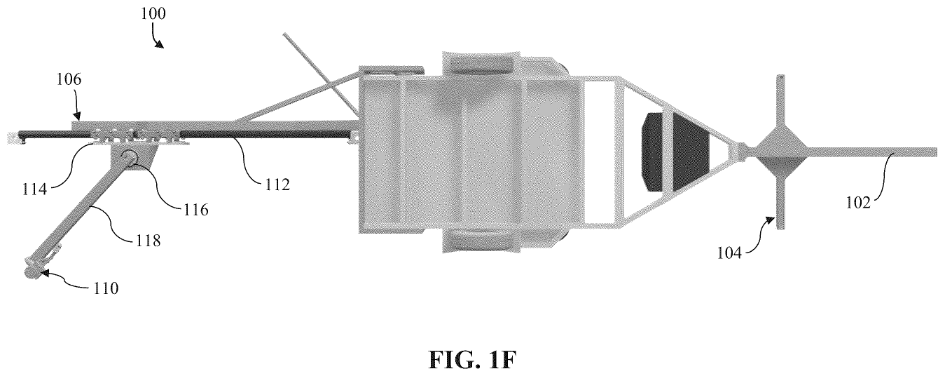

Referring to FIGS. 1A-1F, a system 100 for automated paved surface sealing is depicted according to an embodiment. System 100 is configured to seal pavement features while being towed from a vehicle (not shown) via trailer coupler 102. In other embodiments a system incorporating the elements of system 100 can be mounted on an existing crack sealing unit or a dedicated vehicle, such as a specially designed truck. In embodiments that incorporate sealant arm module 106 into a dedicated vehicle, system 100 can be placed on the side of the vehicle or underneath the vehicle bed. In embodiments, sealant arm module 106 can be positioned underneath a trailer. System 100 generally comprises imaging module 104 and sealant arm module 106.

Imaging module 104 is configured to capture and store digital images. Although not depicted, imaging module includes one or more devices capable of capturing, detecting, or recording images, such as a camera. In embodiments, imaging module 104 can include a single camera or a camera array comprising two or more cameras. In embodiments, the cameras incorporated into imaging module 104 are three mono (black and white) cameras. In some embodiments, imaging module can include an image sensor or a combination of image sensors. Any images produced by imaging module 104 can be transmitted to a processor of system 100 and/or a remote server for processing and pathing analysis.

Imaging module 104 is generally positioned ahead of sealant arm module 106 relative to the direction of motion such that paved surfaces pass image module 104 first when in motion. Because system 100 is configured to be towed behind a vehicle, imaging module 104 is positioned proximal to the vehicle whereas sealant arm module 106 is positioned distal to the vehicle. The distance between the imaging module 104 and sealant arm module 106 enables a sealant path to be determined before the arm reaches the location the image was taken, allowing for sealant application while moving.

Sealant arm module 106 is configured to allow for flexible movement of crack sealing applicator 110 based on analysis of paved surface images from imaging module 104. To achieve this mobility, in this embodiment sealant arm module 106 comprises linear rail 112, stroke actuator 114, and revolute joint 116. Stroke actuator 114 is configured to move along linear rail 112 which collectively act as a prismatic joint. Crack sealing applicator 110 is coupled to stroke actuator 114 via revolute joint 116 to facilitate a greater range of movement. The length of linear rail 112 can enable more efficient sealing paths as many cracks are longitudinal. Revolute joint 116 enables crack sealing applicator 110 to reach the edges of paved surfaces, such as the lane shoulder of a road or across lane boundaries. In embodiments, nonlinear rails and other joint arrangements may be used based on job requirements (e.g., necessary range of motion of crack sealing applicator 110). In embodiments, sealant arm module 106 is a Selective Compliance Articulated Robot Arm (SCARA). Sealant arm module 106 system employs two-dimensional arm movement to reduce complexity with fewer moving parts (e.g., lower cost) than other automated designs.

Crack sealing applicator 110 is configured to seal cracks or other features of paved surfaces by depositing sealant and includes floating sealant axis 120, secondary revolute joint 122, hot air lance 124, sealant applicator 126, hose connector 128, and squeegee 130. Hose connector 128 is configured to removably couple a sealant hose. Floating sealant axis 120 ensures squeegee 130 remains on the paved surface to apply sealant from sealant applicator 126 evenly. Hot air lance 124 is coupled to sealant applicator 126 via secondary revolute joint 122, which allows hot air lance 124 to be oriented independently of sealant applicator 126.

Hot air lance 124 can be oriented to blow hot air in the direction of cracks that are next in order to be sealed. Hot air lance 124 clears debris, dries, and heats cracks directly before the cracks are sealed. In embodiments the motion of hot air lance 124 is controlled by a path planning algorithm that factors in the constrained position of hot air lance 124. The proximity of hot air lance 124 to sealant applicator 126 ensures the pavement is hot and the crack is clear of debris and is dry as the sealant is applied for optimal sealant adhesion.

The integration of hot air lance 124 into crack sealing applicator 110 represents an improvement over conventional systems as the sealant creates a more effective seal since the crack is free of vegetation, debris, moisture, and is pre-heated. Many conventional automated systems fail to incorporate a means of preparing cracks with a heat lance such that seals often suffer from reduced adhesion and effectiveness.

In embodiments, system 100 includes control cabinet 118 configured to store a physical computing environment and/or electric motor drives. System 100 can further comprise one or more of an air compressor, a generator, a battery, and a sealant melter.

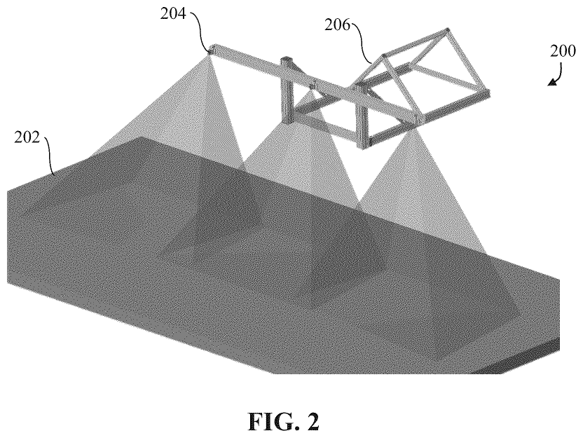

Referring to FIG. 2, a camera mounting system 200 that can be used to support cameras of imaging module 104 is depicted according to an embodiment. Camera mounting system 200 can be mounted on a vehicle (not shown) to capture images of a pavement surface 202 with cameras 204 mounted on frame 206. In embodiments, one or more mono 2D cameras 204 can be positioned on frame 206. In some embodiments, cameras 204 can be mounted inside waterproof enclosures. Frame 206 can be constructed from one or more of metals, woods, or plastics. In an embodiment, frame 206 comprises aluminum.

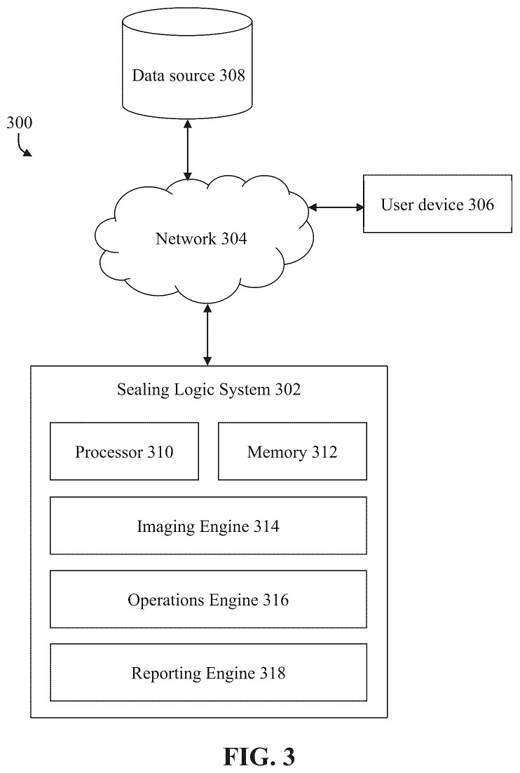

Referring to FIG. 3, a block diagram of a system 300 for automated paved surface sealing is depicted according to an embodiment. System 300 is configured to detect and seal pavement features while in motion and generally comprises sealing logic system 302, network 304, user device 306, and data source 308.

In embodiments, sealing system 302 can be portable hardware configured to mount on a vehicle and provide vehicle position tracking, triggering, image acquisition, pavement feature detection, feature filtering, mapping, path planning, heat lance control, and sealant arm control. Heat lance control can include debris removal, crack preparation, and/or other uses of an air lance that do not require heating. In embodiments sealing logic system 302 is configured to control operation of system 100. Sealing system 302 generally comprises processor 310, memory 312, and one or more modules, such as imaging engine 314, operations engine 316, and reporting engine 318.

Processor 310 can be any programmable device that accepts digital data as input, is configured to process the input according to instructions or algorithms and provides results as outputs. In an embodiment, processor 310 can be a central processing unit (CPU) or a microcontroller or microprocessor configured to carry out the instructions of a computer program. Processor 310 is therefore configured to perform at least basic arithmetical, logical, and input/output operations.

Memory 312 can comprise volatile or non-volatile memory as required by the coupled processor 310 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, or imaging disc storage, for example. The foregoing lists in no way limit the type of memory that can be used, as these embodiments are given only by way of example and are not intended to limit the scope of the present disclosure.

The use of the term “engine” herein refers to any hardware or software that is constructed, programmed, configured, or otherwise adapted to autonomously carry out a function or set of functions, such as controlling one or more cameras or communicating with data source 308. Engine is herein defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out.

In embodiments, each engine can itself be composed of more than one sub-engine, each of which can be regarded as an engine in its own right. Moreover, in the embodiments described herein, each of imaging engine 314, operations engine 316, and reporting engine 318 correspond to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Sealing logic system 302 can be implemented irrespective of the number or type of engines. In embodiments, imaging engine 314, operations engine 316, and/reporting engine 318 can be within or outside the structure of system 100, such as being stored in a housing independent of the vehicle trailer or mount. For example, operations engine 316 can be located at a server remote from hardware mounted on a vehicle.

Imaging engine 314 is configured to track distance of a vehicle, capture imagery at set distances, and process and stitch imagery from multiple cameras. For example, imagine engine 314 can include distance tracking hardware (e.g., radar, inertial measurement unit (IMU), encoder) communicatively coupled to a microcontroller, such as processor 310, that can trigger image acquisition of pavement segments from one or more mounted cameras at set distances such that the images can be stitched together to create a map of the pavement surface.

Imaging engine 314 is configured to calibrate and operate one or more cameras, such as cameras of imaging module 104, and maintain a sensor log. Camera calibration can include one or more of implementing coded calibration functions, lens distortion correction, converting images to a top-down view to remove camera angles, stitching across cameras using markers, and cropping. In embodiments, imaging module 104 is fixed to a trailer or vehicle configured to seal cracks such that calibration is not required between uses. In other embodiments, calibration is done each time imaging module 104 is mounted to a new vehicle. Stitching of images as used herein primarily refers to stitching the side-by-side camera views at a single location. However, in some embodiments stitching sequential views as the camera travels down the road can also be carried out. Once images have been acquired, imaging engine 314 is configured to process images (e.g., transforming, stitching, equalizing, cropping).

Operations engine 316 is configured to import images from imaging engine 314 and conduct semantic segmentation and skeletonization to identify surface features, such as cracks. In embodiments, pixels identified as cracks are also stitched sequentially with regard to the origin of the sealing system frame. In embodiments, operations engine 316 can implement machine learning models for image segmentation and inference as will be described later.

In embodiments, operations engine 316 detects all cracks and then filters the cracks based on width of crack and density of cracking to determine which cracks to actually seal. Crack filtering improves efficiency of the crack sealing process as it is generally not cost effective or advantageous to seal very small or very large cracks, or sprawling networks of dense cracks. Operations engine 316 then produces a map of cracks to be sealed and an efficient path is generated for sealant arm module 106 to follow.

In embodiments, operations engine 316 takes the map of cracks to be sealed and the path to follow and determines the poses of each joint of sealant arm module 106, such that heat lance 124 precedes crack sealing machine 110 and follows the predetermined-path, modulating the sealant flow according to applicator position and the volume of sealant needed at a particular point.

Reporting engine 318 is configured to support customizable queries to summarize sealing statistics over various intervals and include a web interface to generate an actionable report of pavement status. The report can include a high-level summary with one or more of location sealed, the length, width, and temperature of applied sealant, density of sealant used over the pavement length, and sealant quantity used.

In embodiments, network 304 can be in communication with a server, such as a cloud-based server, that can include a memory and at least one data processor. In such embodiments the server can remotely process one or more computing tasks of sealing logic system 302.

User device 306 generally comprises processing and memory capabilities and can establish a wireless or wired connection with network 304 or otherwise communicate to sealing logic system 302, such as by Bluetooth or ad hoc Wi-Fi. Examples of user device 306 include smartphones, tablets, laptop computers, wearable devices, other consumer electronic devices or user equipment (UE), and the like. The term “user device” will be used herein throughout for convenience but is not limiting with respect to the actual features, characteristics, or composition of the device that could embody user device 306. In embodiments, user device 306 can run an instance of a user interface designed to facilitate user interaction with one or more features of sealing logic system 302.

The user interface can include data fields configured to receive user inputs and provide user outputs regarding configuration and status of system 100 and/or sealing logic system 302. In some embodiments, the user interface can comprise a mobile application, web-based application, or any other executable application framework. In such embodiments, the user interface can reside on, be presented on, or be accessed by any computing devices capable of communicating with the various components of system 100 and/or sealing logic system 302. In embodiments, the user interface can be presented on user device 306 within a vehicle to which system 100 is mounted. In such embodiments, the user interface can display diagnostic information, such as status indicators of each module of system 100, to a driver or passenger of the vehicle so that system information can be monitored during use.

The user interface can additionally enable system control, such as enabling a user to run calibration and access calibration information and start, pause, or stop sealant application. In embodiments, users can add a live video feed or static image retrieval via the user interface.

In one aspect, user device 306 can have a wired connection to sealing logic system 302 such that connecting via network 304 is not necessary. This arrangement can be useful when user device 306 is located in a vehicle with sealing logic system 302 as user device 306 can store captured images that will later be uploaded to data source 308 or a remote processing server. In embodiments, user device 306 can be a laptop in a truck behind which system 100 is towed.

Data source 308 can be a general-purpose database management storage system (DBMS) or relational DBMS as implemented by, for example, Oracle, IBM DB2, Microsoft SQL Server, PostgreSQL, MySQL, SQLite, Linux, or Unix solutions. Data source 308 can store one or more data sets associated with user device 306. In embodiments, data source 308 can be native to sealing logic system 302 such that no connection to network 304 is necessary.

One purpose of data source 308 is to store a plurality of navigational data that can map) locations of captured images such that sealant reports can be compared for different road segments, as necessary. Location information communicated to sealing logic system 302 can be an effective way to compare pavement conditions along roads and provide summaries of repairs and associated costs.

In operation, imaging engine 314 can acquire images via imaging module 104 based on distance traveled by system 100 as determined by one or more wheel sensors and/or radar based measurements. In embodiments using one or more wheel sensors mounted to a wheel hub of a vehicle upon which system 100 is mounted, a quadrature encoder driven distance measurement can be used to trigger photo acquisition. In other embodiments, or to improve the accuracy of embodiments incorporating wheel sensors, a radar-based distance measurement can be used. A radar, such as an agriculture doppler radar, can be used in conjunction with one or more wheel sensors, accelerometers, magnetometers, global navigation satellite system (GNSS) receivers, and an extended Kalman filter for sensor fusion to estimate the pose and velocity of system 100.

Based on this pose and velocity information, imaging engine 314 sends a hardware trigger signal to cameras of imaging module 104 each time a set distance is traveled. The set distance is based on the field-of-view (in the direction of motion) of images captured as determined during calibration. Imaging engine 314 can further log GPS points and vehicle pose at the time the hardware trigger signal is sent such that captured images are mapped to locations along pavement segments.

Optionally, two or more cameras each capture sequential images of a pavement surface that are stored in separate video files according to embodiments. Calibration data can later be used to stitch images from each camera for a particular point in time into a single image for analysis. Imaging engine 314 can analyze video files frame by frame. Each frame is transformed, deskewed, and transformed to a top-down view before the frames are stitched together and cropped into a single image. Imaging engine 314 can then upload imagery and GPS data logged by system 100 to a backend pipeline for processing by operations engine 316.

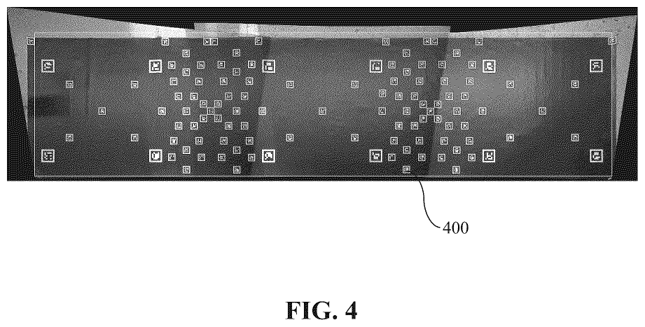

Stitching across cameras can be accomplished using ArUco markers as shown in FIG. 4. ArUco markers 400 are synthetic square markers composed by a wide black border and an inner binary matrix which determines its identifier. These identifiers can be compared by imaging engine 314 such that each image can be overlaid on one another to create a single composite image. For example, FIG. 4 depicts three images that have been stitched together. Imagine engine 314 can then crop the stitched images for more efficient analysis. Stitched images can also be equalized to improve contrast and consistency of imagery. Stitching parameters can be stored and re-used so long as the position and orientation of imaging module system 104 remains unchanged relative to sealant arm module 106.

Embodiments of operations engine 316 implement artificial intelligence (AI) or machine learning (ML) for image segmentation of 2D images of pavement such that pavement features can be detected for each pavement segment. Using skeletonization of crack features, a single pixel-width network of cracks can be generated for each pavement segment, a path for sealant arm module 106 can be planned that follows or avoids select features, and control logic for applying sealant can be determined.

Visual characteristics of pavement conditions can be extracted manually or automatically by machine learning approaches such as, for example, convolutional neural networks, to produce labeled images on a pixel-by-pixel basis. These visual characteristics can be determined by operations engine 316 and can each be associated with a particular crack network and stored in data source 308 for future visual characteristic recognition. Such analysis can be accomplished through associating each pixel with a numerical value based on at least one of color or grayscale of the pixel. A neural network configured to determine a probability of the pixel representing at least a portion of a pavement feature can then assign labels to each pixel based on these numerical values and comparisons to trained data. In embodiments, labels can include one or more of crack, grass, pavement, not-pavement, concrete, paint, and the like. Accordingly, the ML model can be efficiently applied to labelled (supervised) image data by operations engine 316. In embodiments, unlabeled (unsupervised) image data can be used although accuracy and precision of the ML model will perform comparatively worse without more extensive training.

In embodiments, training data can include a plurality of images having labeled cracks occurring at different locations within the image. With sufficient training from such examples the ML model can better recognize when visual characteristics of an image may belong to pavement variances rather than actionable cracks or other anomalies. In embodiments, the comparison process can be accomplished by computing similarity metrics using correlation or machine learning regression algorithms. For example, if the similarity of a pixel to the crack label is above a certain threshold, (e.g., 75%, 90%, 95% or 99% similarity) the matching process can determine that the pixel represents a crack in the pavement and the crack label can be assigned. This analysis can be improved during operation by inclusion of feedback loops directed to classifying visual characteristics of cracks based on determined accuracy of previously assigned labels. As more comparisons between images and labeled data are made, visual characteristic data (i.e., length, width, and depth of cracks) can be tracked to better recognize the starting and ending points of cracks within an image.

In one aspect, operations engine 316 can implement one or more classifiers to consider parameters such as type of image (a mono image compared to a color image may have different parameters or visual characteristics for example) and type of pavement.

Operations engine 316 can be trained to trim visual characteristics that are assigned the not-pavement label. In embodiments, the trimming process can determine that the column of pixels represents not-pavement, based on assigned labels, and can be trimmed. In embodiments, this process can be completed by comparing columns of pixels inwards from the left and right boarders of the image and/or by comparing rows of pixels inwards from the top and bottom boarders of the image. In such embodiments, the trimming can be stopped once the test fails from one or all sides.

In embodiments, when determining the best path, operations engine 316 can ignore or avoid locations with not-pavement, manhole, storm drain, or other labels representing features that should not be sealed or traveled over.

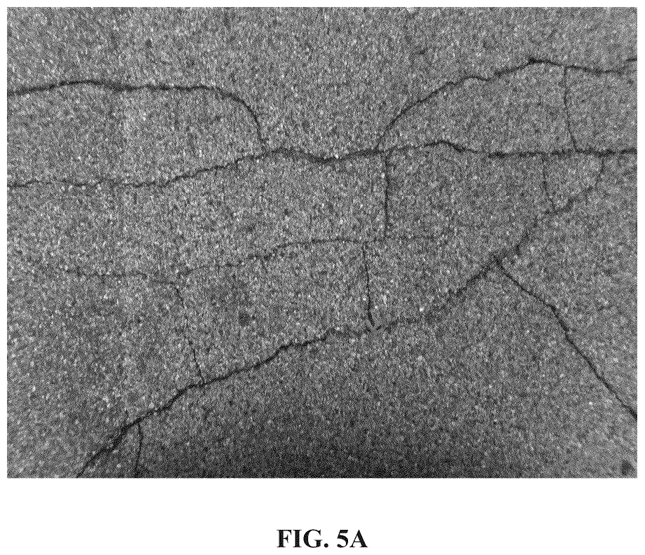

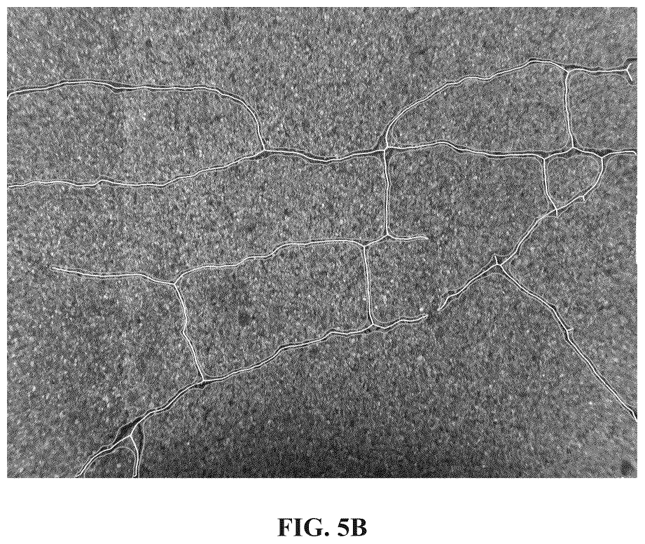

Referring now to FIG. 5A, a sample image of a pavement segment with cracks is depicted. FIG. 5B depicts the image of FIG. after being run through the ML image segmentation pipeline such that the crack skeleton and the pixels assigned the crack label are identified.

The required threshold for a pixel to be labeled a crack can be altered. Such an arrangement can improve crack recognition in situations where the system is attempting, yet repeatedly failing, to produce a sufficiently labeled image. In embodiments, one or more feedback loops can alter parameters of the image recognition ML model to personalize the labeling experience for different pavement types, camera arrangements, and the like. Parameters can include one or more of intensity of the matching threshold and whether the matching threshold is changed universally or for only one or more labels identified as being problematic.

With continued reference to FIG. 3, operations engine 316 can implement morphological operations (erosion/dilation) to reduce gaps in detected crack segments. Cracks tend to connect in a crack network so small gaps between cracks are likely caused by debris in the crack causing it not to be detected. In some instances, these gaps can be resolved using morphological operations.

A skeletonization algorithm implemented through a computer vision library can reduce crack labeled pixels to a single pixel-width network of cracks. This reduction allows for splitting the crack network into distinct branches and calculating the length of each crack. Each separate crack branch can be analyzed to determine one or more of average branch width, branch length (exact length following contours of the crack), fuzzy branch length, and crack density per area of roadway. Fuzzy branch length is representative of a tape measure value of the crack that can be calculated by calculating a statistical best fit and then recalculating the length using standard distance measuring formula. In embodiments data for each branch is saved to data store 108 so the branch data can be filtered using custom queries. The area of pavement captured can also be logged and possibly trimmed if some threshold percentage of pixels is labeled not-pavement in a continuous block.

Once a map of cracks has been generated, operations engine 316 is configured to implement intelligent path planning to efficiently seal all the cracks while vehicle is in motion.

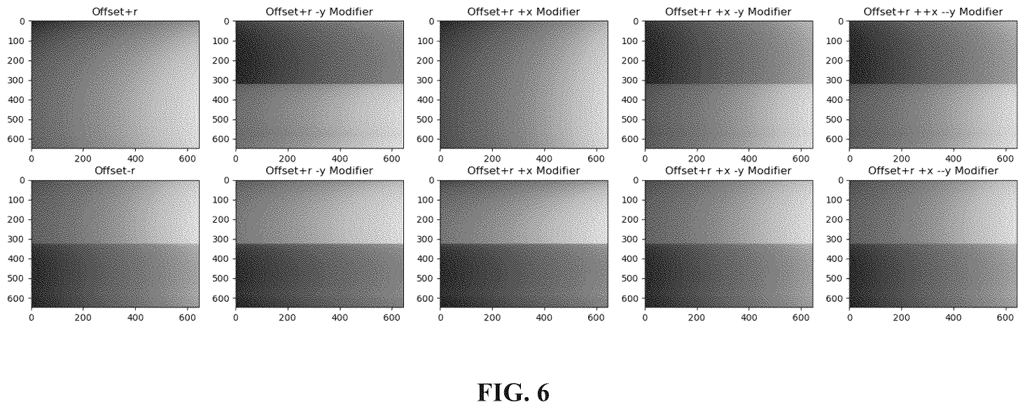

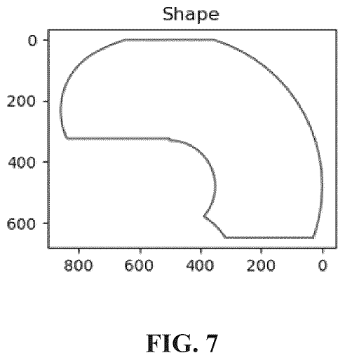

Referring to FIG. 6, graphs of cost gradients associated with each pixel are depicted according to an embodiment. Each cost gradient is based on the area the robotic arm can cover and the distance between movements as shown in FIG. 7. The shape of reach for the robotic arm is based on the selected arm configuration and will change between some embodiments. Operations engine 316 lowers the cost as the crack gets closer to going out-of-reach and increases the cost based on how quickly the crack comes into reach and the ratio of the area where the crack is reachable. In addition, the cost can be related to the velocity of the vehicle and the time it takes to move the sealant applicator from its current position to a target position. In embodiments, the cost function can be static. In other embodiments, the cost function can update in real-time.

Operations is further configured to manipulate sealant arm module 106 in accordance with the produced sealant path, such that sealant can automatically be applied while the vehicle is in motion based on the cost function. In embodiments sealant path can be stored in data source 308 or sent to an operator application running on user device 306. The operator application can allow a user to monitor equipment or view data, such as the sealant path, in real time.

In embodiments, the operator application can provide a web interface for mapping and data logging. The operator application can include data on one or more of temperature, sealant status, hose status, applicator state, humidity, speed over ground, location, and sealant laydown density. Diagnostics, reliability, and usage reporting can also be presented through a user interface or the operator application. The operator application can further display the optimal driving speed. The system needs to communicate the optimal driving speed to the operator to go as fast as possible, which is a function of the amount of cracking identified in the pavement surface. Specifically, the volume of required sealant and length of cracking are used to arrive at the achievable speed of operation of the system.

In embodiments, reporting engine 318 can comprise a flexible web portal that provides data reports and filtering capabilities. Generated reports can include, location, surveyed length and width of cracking, density of cracking over road length, and sealant quantity used to remedy cracks. Although reduced to single pixel width for measuring length, the width of each crack is stored for use in calculating volume of material needed.

Embodiments of the present disclosure allow for automated sealing of paved surfaces and are less labor intensive, safer, and quicker than conventional sealing approaches. Further, the automatic sealant system provided by the present disclosure can ensure a higher quality sealant product by performing proper crack preparation and reducing inconsistences resulting from human error and subjectiveness in crack sealing. Since feature analysis of the paved surface is deterministic, quality of the described system will be consistent.

Conventional manual sealing requires 4-7 workers to complete a maximum of 4-7 lane miles per day. Quality of this manual sealing can be inconsistent, and workers are exposed to passing road traffic. Embodiments of the present disclosure do not require two workers to be sealing cracks, nor a third worker who would be responsible for blowing out the cracks. Traffic control may still be required, but if the system is moving fast enough, not in a high-traffic area and equipped with proper warning devices, traffic control may not be required. This means automated sealing as described herein can be accomplished at high speed by as few as one worker, who for the most part will remain in their vehicle, and can cover 8 or more lane miles per day.

System 100 as controlled by sealing logic system 302 also realizes speed gains over conventional solutions. The automated system can operate for longer periods of time and can move faster than a person manually applying sealant. This increased sealing speed will also reduce the length of lane closures, which in some cases may not even be necessary. Accordingly, teaching of the present disclosure represents an improvement over conventional crack sealing approaches that fail to efficiently process and leverage 2D image data in real time.

Moreover, system 100 overcomes the shortcomings of conventional systems that require a shroud to limit lighting differences over the pavement segments being analyzed. Embodiments of the present disclosure can more effectively account for variances in lighting based on both the camera settings used (and the implementation of 2D cameras) and the training of the ML model to recognize and ignore variances caused by differences in lighting. System 100 can include additional lighting to improve image engine operation in low-light scenarios, enabling the system to be used at night.

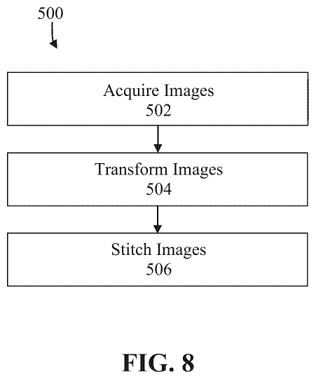

Referring now to FIG. 8, a flowchart of a method 500 for acquiring and processing pavement images is depicted. Method 500 can be implemented by sealing logic system 302 such as via system 100.

At 502 images are acquired from a system including, for example, three cameras mounted on a moving vehicle. In embodiments, the system acquires images as the system is driven down a roadway. The process of capturing each image is timed such that no portion of the pavement segment is missed between images. In some embodiments, the images for each roadway are saved as a video. The video files can then be automatically or manually transferred to a server or data store.

At 504 the separate images acquired by each camera at a given location are transformed. The transformation process is based on a calibration routine that is run after the system is first mounted to the vehicle. The calibration routine transforms the images to account for camera lens distortion. The calibration routine calculates a transformation to an orthographic top-down projection which is determined by analyzing a teaching grid placed on the ground. The grid has several markers, which the system locates and identifies. The calibration routine looks for the markers that are stored with a specific location and from that information the necessary transformation to correct for the skewing of the camera.

At 506 the three camera images are stitched (combined) into a corrected composite image of the road. Notably, in embodiments this stitching is of images captured simultaneously, or near-simultaneously, between the three cameras. Subsequent images from each camera are not stitched together in some embodiments.

Although described with respect to three cameras, method 500 can be applied to any system incorporating one or more cameras.

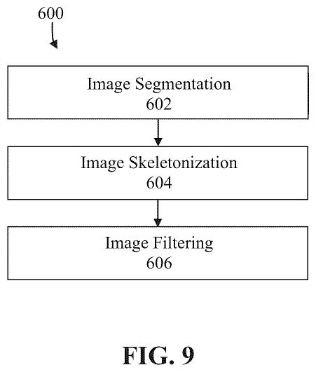

Referring now to FIG. 9, a method 600 for analyzing composite images of pavement segments is depicted according to an embodiment. In embodiments, method 600 can be applied to a composite image such as that produced by method 500 of FIG. 8.

At 602, an image is broken down into smaller images that are run through a ML pipeline. The ML pipeline applies image segmentation to identify which pixels are crack, pavement, not-pavement (i.e., not-road), and sealant. The ML pipeline identifies pixel patterns by comparisons to training data sets.

At 604 the smaller images are run though a refinement process including skeletonization to isolate crack segments from pavement. The refinement process can include removal of gaps within crack networks to correct for debris. The output of ML pipeline is then characterized by length, width, location, and other information for each crack network and saved to a database.

At 606 a user interface allows a user to filter images. The user can select a specific road segment for which the associated crack data is retrieved from the database. The user interface can allow a user to filter cracks based on characterizations (e.g., length, width). In embodiments, the user interface generates a report based on the data stored in the database and filters applied by the user.

In embodiments, images can further be enhanced to improve feature recognition and contrast. Images can also be cropped to reduce file sizes and remove portions of the images that are marked as non-pavement.

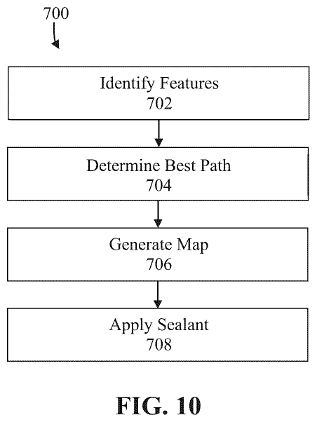

Referring to FIG. 10, a method 700 for automatically applying sealant is depicted according to an embodiment. In embodiments, method 700 can be processed by operations module 316 and implemented by sealant arm module 106.

At 702 features are identified in acquired images. In embodiments, images can be processed or filtered based on desired filters. For example, it is generally not cost effective or advantageous to seal very small cracks so such cracks can be excluded based on width measurements.

At 704 a best path for sealant arm module 106 is determined by operations module 316. The order features should be sealed is determined by the path planning system employing a cost function based on the velocity of system 100, the reach of sealant arm module 106, and the time required to move crack sealant machine 110 from its current position to a target position. The efficiency and movement cost of moving sealant arm module 106 is considered such that a crack that is entirely within reach may be sealed before sealant arm module 106 moves to another crack.

At 706 a map of features is generated. The feature map can be stored in a list (i.e. a matrix) of points with location information in the order in which they should be sealed. The feature map is stored in a datastore, such as data source 308 and can be tagged with photo id they were derived from. Operations module 316 tracks the photo location and performs the matrix transform needed to put the points into the correct location accounting for the movement of the vehicle. Operations module 316 then updates the point locations at each new update of the vehicle tracking system.

Notably while the map of features is generated for a particular portion of the paved surface, imaging engine 314 continues to activate the hardware trigger of imaging module 104 to take the next photo. Additionally, embodiments of the vehicle tracking system can take data from a IMU unit to correct for orientation drift during use.

At 708, operations module 316 commands sealant arm module 106 to apply sealant based on the order of the feature map. Commands can be issued to open and close sealant applicator 126 and control one or more motors of actuators. In embodiments, sealant applicator can be controlled to a finer degree by partially opening (e.g., opening 50% or 70%).

It should be understood that the individual operations used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Embodiments of the present disclosure allow users to quickly determine the extent of cracking on road segments and filter cracks based on desired parameters for sealing, allowing an automated sealing process while in motion. The ability to filter by cracks that meet specified size criteria, image the roadway without using a shroud, remove vegetation, debris, and moisture using a hot air lance attached to the sealant application machine, ignore or avoid locations that should not be sealed or traveled over, efficiently plan the best path while vehicle is in motion, apply sealant while in motion, and to easily incorporate the hardware system to an existing vehicle represent improvements over various conventional automated solutions. In embodiments, the vehicle can be a drone or unmanned vehicle.

While described with respect to crack sealing, embodiments of the present disclosure can be used for automated routing. Such embodiments incorporate routing tool such as a spindle, a saw, or a rotary blade on the robotic arm that is operated by a motor. Additionally, robotic routing and vacuuming of asphalt and concrete cracks or crack filling (e.g., concrete) could be accomplished using system 300 and a modified robotic arm module.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for identifying and sealing cracks of a paved surface, comprising:
a camera coupled to a vehicle;
a robotic arm including one or more actuators configured to affect motion of the robotic arm, and a distal sealant applicator positionable in proximity to the paved surface, the robotic arm coupled to the vehicle at a location behind the camera relative to a direction of movement of the vehicle;
at least one processor configured to:
selectively trigger the camera to capture images of the paved surface;
determine, for each captured image using image recognition, that a plurality of pixels meets or surpasses a similarity threshold of a crack;
generate a priority list of the plurality of pixels based on a cost function; and
command the robotic arm to apply sealant to the paved surface at locations corresponding to each of the plurality of pixels based on the priority list.

2. The system of claim 1, wherein selectively triggering the camera is based on distance traveled by the vehicle as determined by one or more of a wheel encoder, a radio detection and ranging equipment, or a global navigation satellite system (GNSS).

3. The system of claim 1, wherein the robotic arm further includes a hot air lance positionable ahead of the distal sealant applicator relative to the direction of movement of the sealant applicator.

4. The system of claim 3, wherein the hot air lance is configured to perform one or more of clean, air blow off, and pre-heat the cracks prior to sealing.

5. The system of claim 1, wherein control of the robotic arm is implemented across two-dimensions.

6. The system of claim 1, wherein the processor is further configured to determine a crack width based on the plurality of pixels.

7. The system of claim 6, wherein a quantity of sealant applied to each location varies according to the determined crack width.

8. The system of claim 1, wherein the cost function is based on one or more of effective reach of the robotic arm, velocity of the vehicle, a relative position of a pixel of the plurality of pixels, and an estimated time to move the sealant applicator from one point to another.

9. The system of claim 1, further comprising a user interface configured to provide real-time data including optimal driving speed, one or more of the captured images, robotic arm status, sealant applied, or road information.

10. The system of claim 1, wherein the robotic arm further includes one or more of a saw, a spindle, or a rotary blade as a routing tool, wherein the processor is further configured to:
command the robotic arm to deploy the routing tool to the paved surface.

11. A method for identifying and sealing cracks of a paved surface, comprising:
capturing images of the paved surface with a camera coupled to a vehicle;
determining, for each captured image using image recognition, that a plurality of pixels meets or surpasses a similarity threshold of a crack;
generating a priority list of the plurality of pixels based on a cost function;
actuating one or more motors of a robotic arm including a distal sealant applicator such that the distal sealant applicator is proximate to a location of the paved surface corresponding to the plurality of pixels based on the priority list;
applying sealant to the location via the distal sealant applicator.

12. The method of claim 11, wherein capturing images is based on distance traveled by the vehicle as determined by one or more of a wheel encoder, a radio detection and ranging equipment, or a global navigation satellite system (GNSS).

13. The method of claim 11 further comprising, pre-heating the location with a hot air lance included in the robotic arm prior to applying sealant.

14. The method of claim 11, wherein the robotic arm is restricted in motion to two-dimensions.

15. The method of claim 11 further comprising, determining a crack width based on the plurality of pixels prior to applying sealant.

16. The method of claim 15, wherein a quantity of sealant applied to each location varies according to the determined crack width.

17. The method of claim 11, wherein the cost function is based on one or more of effective reach of the robotic arm, velocity of the vehicle, a relative position of a pixel of the plurality of pixels, and an estimated time to move the sealant applicator from one point to another.

18. The method of claim 11 further comprising, presenting, via a user interface, real-time data including one or more of the captured images, robotic arm status, sealant applied, or road information.

19. The method of claim 11 further comprising, commanding the robotic arm to deploy a routing tool to the paved surface, wherein the routing tool is one or more of a saw, a spindle, or a rotary blade.

20. A non-transitory computer-readable storage medium storing executable instructions that when executed on a processor, cause the processor to carry out the method of claim 11.
